(19) United States
(12) Patent Application Publication
(10) Pub. No.: US 2024/0212037 A1
(43) Pub. Date: Jun. 27, 2024

(54) Marketplace Utilizing a Currency Issued by Donation

(71) Applicants: Zubin Faiz Wala, Carbondale, IL (US); Pooja Wala, Carbondale, IL (US)

(72) Inventors: Zubin Faiz Wala, Carbondale, IL (US); Pooja Wala, Carbondale, IL (US)

(21) Appl. No.: 18/088,553

(22) Filed: Dec. 24, 2022

(51) Int. Cl. G06Q 30/08

(52) U.S. Cl. CPC G06Q 30/08

(57) ABSTRACT

In various embodiments, a currency, virtual or otherwise, units of which are newly issued when a person donates goods, or services to a marketplace. This currency is utilized in the purchase of donated goods and services through an auction to give an initial exchange ratio or price. This exchange ratio can be further altered through a variety of actions including but not limited to the creation of additional currency, additional auctions utilizing a similar donation, and additional extra-auction exchanges within the marketplace. Exchange ratios in the marketplace are available for inspection and analysis to determine the purchasing power of the currency. Cost recovery options for the marketplace include but are not limited to subscriptions, transaction fees, and payment for services or the like utilizing the issued currency

### CROSS-REFERENCE TO RELATED APPLICATION

Not Applicable

### STATEMENT REGARDING FEDERALLY SPONSORED RESEARCH OR DEVELOPMENT

Not applicable

### THE NAMES OF THE PARTIES TO A JOINT RESEARCH AGREEMENT

Not applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not applicable

### STATEMENT REGARDING PRIOR DISCLOSURES BY THE INVENTOR OR A JOINT INVENTOR

Not applicable

### BACKGROUND OF THE INVENTION

### Field of the Invention

This present invention is in the field of commerce

This present invention is in the technical field of third-party management

### Description of Related Art

At present there is a variety of currencies, virtual or otherwise, that are issued, administered, and traded among individuals and institutions either physically or on interconnected computer networks. In the case of virtual currency, they exist entirely on bits of digital information stored on servers, personal computers, and mobile computing devices. In the case of physical currency, they are stored in warehouses such as private vaults, banks, or other financial institutions. In a large majority of cases the institutions or third parties which issue and manage these currencies do so in a manner that predisposes the currency to inflation.

Inflation provides no social benefit and results in the redistribution of wealth in favor of firstcomers of the newly issued currency and at the expense of latecomers. Furthermore, it creates illusory profits and distorts economic calculation as prices do not all change uniformly and at the same speed. It leads to a preference by consumers for lower quality goods as a means of adjusting to the price increases. Work declines through the subtle allure of “get-rich-quick” schemes, seemingly within their grasp in the era of ever-rising prices scorning sober effort. Additionally, inflation penalizes thrift and encourages debt as any sum of money borrowed can be returned with money of lower purchasing power. Inflation, therefore, lowers the general standard of living in the very course of creating a misleading atmosphere of prosperity.

### BRIEF SUMMARY OF THE INVENTION

For these reasons, there exists a need by participants in commerce for a method and system for issuing currency in the facilitation of trade that limits if not eliminates the potential of an inflated currency. The present invention addresses this need through a method and system for the creation of money, virtual or otherwise, and a means for the expansion of the money supply in proportion to the increase of goods and services that enter the marketplace. Firstly, the object of this invention is to provide a method and system for issuing currency to those that wish to participate in a marketplace. Secondly, this invention provides a method and system for limiting the expansion of the money supply to what is introduced to the marketplace. Thirdly, this invention provides for a method and system of determining the purchasing power of this currency. Fourthly, this invention provides for a method and system for creating a knowledge base of money-prices of the immediate past for utilizing the currency in the present and future. Fifthly, this invention provides for a method and system of recovering the cost of maintaining and growing the marketplace.

### BRIEF DESCRIPTION OF THE SEVERAL VIEWS OF THE DRAWINGS

FIG. 1 Is a diagrammatic view of the method and process steps of issuing currency units by a marketplace. As goods, or services are donated to the marketplace, currency units are given to donors and furthermore shows how donors utilize the issued currency units to purchase donated items.

FIG. 2 is a typical display of winning bids organized by category and listed in descending order of cost per good/service.

FIG. 3 is a diagrammatic view of inter-donor trade within the marketplace.

FIG. 4 is a diagrammatic view of inter-donor trade within the marketplace using the marketplace auction

FIG. 5 is diagrammatic view of an embodiment for cost recovery for the marketplace

### DETAILED DESCRIPTION OF THE INVENTION

A sample embodiment of the discourse is set forth in the following description, is shown in the drawings and is particularly and distinctly pointed out and set forth in the appended claims. The accompanying drawings, which are fully incorporated herein and constitute a part of the specification, illustrate various examples, methods, and other example embodiments of various aspects of the disclosure. It will be appreciated that the illustrated element boundaries (e.g., boxes, groups of boxes, or other shapes) in figures represent one example of the boundaries. One of the ordinary skill in the art will appreciate that in some examples one element may be designed as multiple elements or that multiple elements may be designed as one element. In some examples, an element shown as an internal component of another element may be implemented as an external component and vice versa. Furthermore, elements may not be drawn to scale.

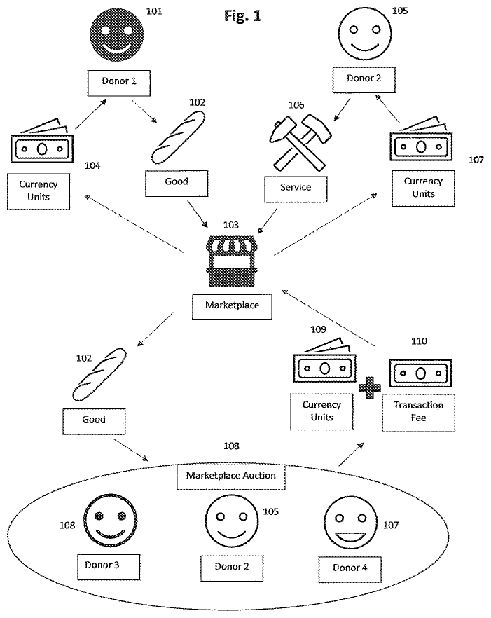

Referring now to the invention in more detail, in FIG. 1, there is shown a diagrammatic view demonstrating an example detailed description of the present invention in which donor 1, 101 donates a good, 102, to the marketplace, 103, which issues currency units, 104, to donor 1, 101, in return for the donated good, 102. Of note the currency unit, 104, is made accessible to Donor 1, 101, through a marketplace exclusive account, digital wallet, physical storage site etc. where the currency unit, 104, is deposited. A similar method and process steps occur with Donor 2, 105, who donates a service, 106, to the marketplace, 103, which issues currency units, 107, to donor 2, 105, in return for the donated service, 106. Again, of note the currency unit, 107, is made accessible to Donor 2, 105, through a marketplace exclusive account, digital wallet, physical storage site etc. where the currency unit, 107, is deposited. This process does not exclude the possibility that the currency unit amount in 104 or 107 could be the same or different. It is conceivable that the donated good, 102, could be stored in a marketplace warehouse or made as a promissory note or other method. In a similar fashion it is conceivable that the donated service, 106, could be donated to the marketplace by a promissory note or other method. The marketplace, 103, offers the donated good, 102, for auction to its donors, 108. The donors interested in the auctioned good, 105, 107, 108, offer various bids until there is a final winning bid. The winning bid donor in this case, 105, transfers their currency units, 109, and in this embodiment a transaction fee, 110, to the marketplace, 103, and in exchange for the donated good, 102. The currency units, 109, are placed in a marketplace account, digital wallet, physical storage etc., 103, are used to perpetuate the cycle of exchanges or if needed newly issued currency would be added to perpetuate the cycle of exchanges of donation for currency units. The transaction fee, 110, would also be placed in a marketplace account, digital wallet, physical storage etc., 103, and is an example of a cost recovery option for the marketplace. It is conceivable that an alternative cost recovery option could take the form of a subscription fee, a payment for services or the like could be used either in addition to or in substitution of the transaction fee. A similar process will occur for donated service, 105. Where this service is auctioned to interested donors. Although this embodiment does not show donor 1, 101, bidding on their donations, this process does not necessarily forbid their participation although it is conceivable that it could.

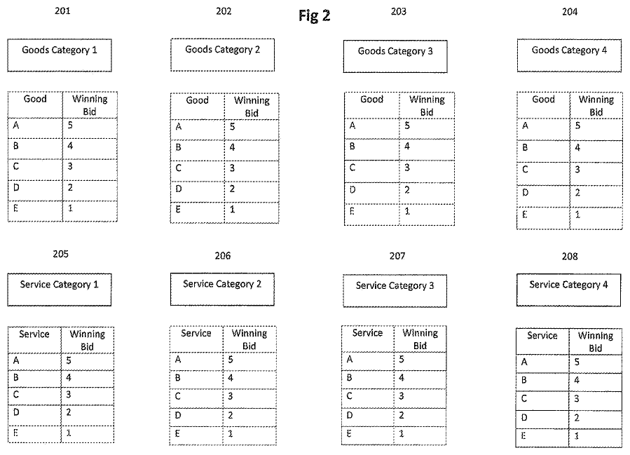

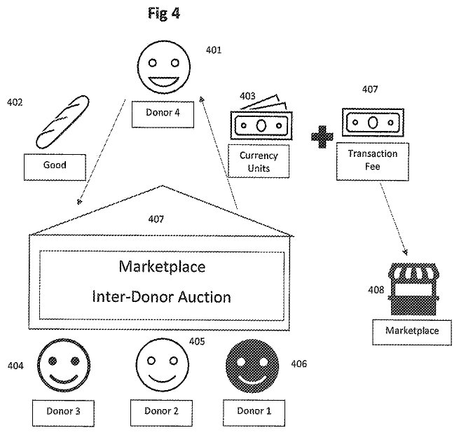

FIG. 2 illustrates an essential aspect of the invention to create a knowledge base of the immediate-past for utilizing the currency in the present. FIG. 2 is an embodiment illustrating this knowledge base with tables displaying winning bids organized by Good Category, 201, 202, 203, 204, and by Service Category, 205, 206, 207, 208. Each table organizes the winning bids in descending order with the highest price item listed first followed by the second and third and so on. The data for filling in these tables are drawn from the activity listed in FIG. 1 and FIG. 4 auction activity. This embodiment shows the top 5 highest priced goods and services.

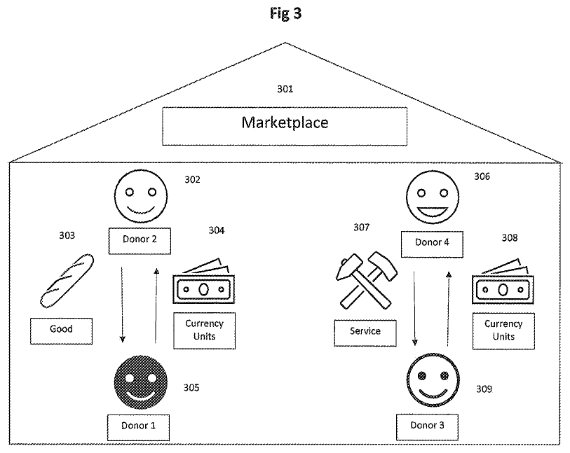

FIG. 3 shows a diagrammatic representation of inter-donor trade utilizing currency units received utilizing the process, and method illustrated in FIG. 1. All inter-donor trade occurs within the marketplace, 301. This is distinct from intermarket transactions, as all currency units, 304, are issued, stored and are accessible within the marketplace for trade within the marketplace. As such the currency units, 304, issued and stored by the method and process illustrated in FIG. 1 are utilized as the medium of exchange. In this embodiment Donor 1, 305, exchanges their agreed upon currency units with Donor 2, 302, for their good, 303. In another iteration of exchange, we see Donor 3, 309, exchanging their currency units, 308, with Donor 4, 306, for a service, 307. In the first exchange, currency units, 304, would be transferred from Donor 1's, 305, account to donor 2's, 302, account. A similar process occurs for the currency units, 309, as the transfer would occur between the storage accounts of Donor 3, 309, and Donor 4, 306.

FIG. 4 shows a diagrammatic representation of inter-donor trade utilizing the currency units received utilizing the process, and method illustrated in FIG. 1 but the exchange of goods and services for currency units occur through a marketplace auction, 407. In this embodiment Donor 4, 401, puts their good, 402, up for auction to the donors in the marketplace, 407. Interested donors, 404, 405, and 406, offer bids of currency units for the good, 402. In this illustration the winning bidder Donor 2, 405, transfers currency units from his, 405, their account, digital wallet, physical storage etc. to Donor 4, 401, account, digital wallet, or physical storage etc. In addition, the transaction fee, 407, would also be transferred from the winning bid donor 2, 405, account, digital wallet, physical storage etc. and transferred to a marketplace account, digital wallet, physical storage etc., 408, and is an example of a cost recovery option for the marketplace. It is conceivable that an alternative cost recovery option could take the form of a subscription fee, a payment for services or the like could be used either in addition to or in substitution of the transaction fee. In this embodiment a good, 402, is placed for auction but it is conceived that a service could be utilized instead.

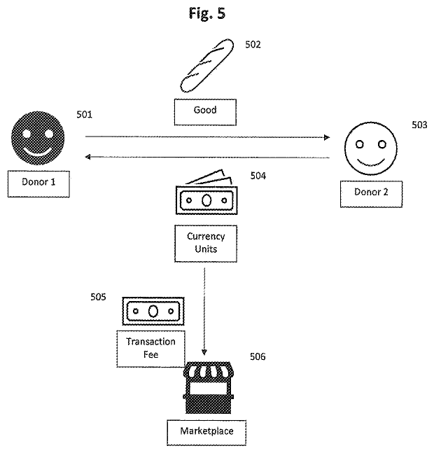

FIG. 5 shows a diagrammatic embodiment of cost recovery for the marketplace based on the issued currency. In this illustration Donor 1, 501, exchanges their good, 502, to Donor 2, 503. In return Donor 2, 503, transfers their currency units, 504, to Donor 1, 501. Again, the currency unit, 504, is a transfer from Donor 2's, 503, marketplace exclusive account, digital wallet, physical storage etc. to Donor 1's, 501, marketplace exclusive account, digital wallet, physical storage etc. During this transaction a transfer fee, 505, is assessed in which a percentage of the currency units, 504, is transferred from Donor 2's, 503, marketplace exclusive account, digital wallet, physical storage etc. to the Marketplace's, 506, marketplace exclusive account, digital wallet, physical storage etc. The Marketplace, 506, then is able to accumulate transaction fees, 505, from other such transactions for use in the maintenance of the marketplace, expansion of the marketplace, or other goal. Although in this embodiment there is an exchange of a good, 502, for currency units, 504, it is conceived that a service could be exchanged in a similar manner.

### MISCELLANEOUS

This disclosure and the following claims incorporate all variants and substitutions that might be attempted by a person having ordinary skill in the art. The design drawings and specifications herein are merely illustrative and are not intended to limit the scope of the disclosure.

Features from any embodiment without departing from the scope of this disclosure.

The words “the,” “a,” and “an” herein are generally intended to mean “one or more” unless otherwise indicated.

1. A system and method for issuing a currency, virtual or otherwise, units of which are newly issued when a person donates goods, or services to a marketplace the process comprising of: a marketplace; accepting donated goods or services; securing the good or service; issuing currency units, virtual or otherwise, to the donor; depositing currency units into a storage vehicle, virtual or physical, exclusive to the marketplace and accessible to the donor; placing the donated good or service for auction to donors of the marketplace; accepting the currency units, virtual or otherwise, as payment for the winning bid; giving the donated good or service to the winning bid donor; using the accepted payment and as needed issuing more currency units to perpetuate the cycle of accepting goods and service for currency units.

2. The system and method of claim 1 further comprising: donors utilizing their stored currency units to exchange with other donors for goods and services directly.

3. The system and method of claim 1 further comprising: donors placing goods and services for auction to other donors; other donors bidding on the auctioned good or service; winning bid donor exchanging their currency units for the auctioned good or service.

4. The system and method of claim 1 further comprising: a display of auctioned goods and services; categorizing of auctioned goods and services and associated winning bids.

5. The system and method of claim 1 further comprising: a method or system for cost recovery for the marketplace; including but not limited to subscriptions, transaction fees, and payment for services or the like using the issued currency.

6. A system and method for implementing and operating the present invention comprises: a method system or application capable of storing user, donor, good, service, sales, order, supplier, vendor, transaction history, currency unit amount and/or any other pertinent data associated with the same; a method, system, or application capable of receiving donated goods, or services; a method system or application capable of issuing currency units for donated goods, or services; a method system or application capable of storing the issued currency for the donor; a method system or application capable of allowing the donor to access and utilize their currency for trading; a method system or application capable of placing goods or services for auction; a method system or application capable of facilitating the auction between the marketplace and among interested donors; a method system or application capable of transferring currency units from the storage vehicle of the winning bid donor and the marketplace; a method system or application capable of facilitating an auction between donors; a method system or application capable of transferring currency units between winning bid donor and auction creator donor; a method system or application capable of facilitating transactions of goods or services between donor; a method system or application capable of facilitating the transfer of currency units among donors; a method system or application capable of displaying the winning bids for goods and services for inspection by all donors in a various manners; a method system or application capable of performing a cost recovery function for the marketplace such as subscription fees, transactions fees and/or payment for services or the like.

7. The application of claim 6 further allows the present invention to be implemented and operated within an application programming interface.

8. The application of claim 6 further allows the present invention to be implemented and operated within a shopping cart plugin or extension.

9. The application of claim 6 further allows the present invention to be implemented or operated within an electronic payment processing terminal, pin-pad device, card reader, payment gateway, tokenization service, EMV device, payment facilitator platform, or P2P payment services including but not limited to trade or bartering software or the like.

10. The application of claim 6 further allows the present invention to be implemented or operated within a point-of-sale application, interface, or other Software-as-a-service that provides point of sale, accounting, invoicing, checkout, gift, loyalty, or rewards functionality.

11. The application of claim 6 further allows the present invention to be implemented or operated within a mobile, cellular, smart television technology application.

12. The application of claim 6 further allows the present invention to be implemented within or operated by gaming or virtual reality software or applications.

13. The application of claim 6 further allows for marketing the currency units using electronic and non-electronic forms of advertising media.
